(19) United States
(12) Patent Application Publication
(10) Pub. No.: US 2024/0399665 A1
(43) Pub. Date: Dec. 5, 2024

(54) MANUFACTURING METHOD OF THREE-DIMENSIONAL MOLDED OBJECT

(71) Applicant: SEIKO EPSON CORPORATION, Tokyo (JP)

(72) Inventor: Wataru ENDO, Shiojiri (JP)

(21) Appl. No.: 18/675,214

(22) Filed: May 28, 2024

(30) Foreign Application Priority Data
May 30, 2023 (JP) 2023-088484

(51) Int. Cl. B29C 64/386; B29C 64/40; B33Y 10/00; B33Y 50/00

(52) U.S. Cl. CPC B29C 64/386; B33Y 10/00; B33Y 50/00; B29C 64/40

(57) ABSTRACT

There is provided a manufacturing method of a three-dimensional molded object that molds a molded object and a support structure on a molding surface. This manufacturing method includes a first step of determining a support region in which the support structure is molded; a second step of receiving division information for dividing the support region determined in the first step into a plurality of regions; a third step of receiving modification information that instructs a modification of a molding condition or a deletion of a divided region for at least one of the plurality of divided regions that are divided in accordance with the division information received in the second step; a fourth step of generating support data for molding the support structure by a three-dimensional molding device in accordance with the support region determined in the first step and the modification information received in the third step; and a fifth step of molding the support structure by controlling the three-dimensional molding device in accordance with the support data.

The present application is based on, and claims priority from JP Application Serial Number 2023-088484, filed May 30, 2023, the disclosure of which is hereby incorporated by reference herein in its entirety.

### BACKGROUND

### 1. Technical Field

The present disclosure relates to a manufacturing method of a three-dimensional molded object.

### 2. Related Art

JP-A-2018-47623 discloses a technique of automatically setting, at an optimal position, a support structure of a molded object to be formed by a three-dimensional printer.

When the support structure is automatically set as in the above literature, while it increases convenience, there is a possibility that the support structure may be placed in unnecessary places. It is also difficult to change a condition for a specific region of the support structure. Thus, there is a need for technology that can easily customize the support structure.

### SUMMARY

According to a first aspect of the present disclosure, there is provided a manufacturing method of a three-dimensional molded object that molds a molded object and a support structure, which supports the molded object, by stacking layers on a molding surface. This manufacturing method includes a first step of determining a support region in which the support structure is molded; a second step of receiving division information for dividing the support region determined in the first step into a plurality of regions; a third step of receiving modification information that instructs a modification of a molding condition or a deletion of a divided region for at least one of the plurality of divided regions that are divided in accordance with the division information received in the second step; a fourth step of generating support data for molding the support structure by a three-dimensional molding device in accordance with the support region determined in the first step and the modification information received in the third step; and a fifth step of molding the support structure by controlling the three-dimensional molding device in accordance with the support data.

### BRIEF DESCRIPTION OF THE DRAWINGS

FIG. 1 is an explanatory view showing a schematic configuration of a three-dimensional molding system.

FIG. 2 is a perspective view showing a schematic configuration of a flat screw.

FIG. 3 is a schematic plan view of a barrel.

FIG. 4 is an explanatory diagram schematically showing how a three-dimensional molding device molds a molded object.

FIG. 5 is an explanatory diagram showing a schematic configuration of an information process device.

FIG. 6 is a flow chart of a molding process executed in the three-dimensional molding system.

FIG. 7A is an explanatory diagram of the molding process.

FIG. 7B is another explanatory diagram of the molding process.

FIG. 7C still another explanatory diagram of the molding process.

FIG. 8A is an explanatory diagram showing another example of the molding process.

FIG. 8B is another explanatory diagram showing another example of the molding process.

FIG. 8C is still another explanatory diagram showing another example of the molding process.

FIG. 9A is an explanatory diagram showing still another example of the molding process.

FIG. 9B is another explanatory diagram showing still another example of the molding process.

FIG. 9C is still another explanatory diagram showing still another example of the molding process.

FIG. 10A is an explanatory diagram showing further example of the molding process.

FIG. 10B is another explanatory diagram showing further example of the molding process.

FIG. 10C is still another explanatory diagram showing further example of the molding process.

FIG. 11A is an explanatory diagram showing further example of the molding process.

FIG. 11B is another explanatory diagram showing further example of the molding process.

FIG. 11C is still another explanatory diagram showing further example of the molding process.

FIG. 12A is an explanatory diagram showing further example of the molding process.

FIG. 12B is another explanatory diagram showing further example of the molding process.

FIG. 12C is still another explanatory diagram showing further example of the molding process.

FIG. 13A is an explanatory diagram showing further example of the molding process.

FIG. 13B is another explanatory diagram showing further example of the molding process.

FIG. 13C is still another explanatory diagram further example of the molding process.

FIG. 14 is a diagram showing a display example of an alert region.

### DESCRIPTION OF EMBODIMENTS

### A. First Embodiment

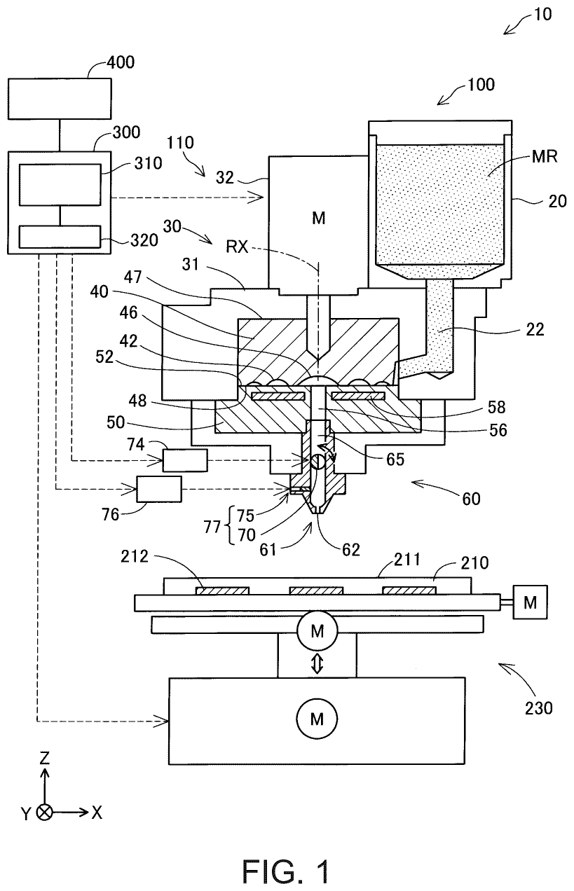

FIG. 1 is an explanatory diagram showing a schematic configuration of a three-dimensional molding system 10 according to a first embodiment. FIG. 1 shows arrows indicating X, Y, and Z directions, which are orthogonal to each other. The X direction and the Y direction are directions parallel to a horizontal plane, and the Z direction is a direction along a vertically upward direction. The arrows indicating the X, Y, and Z directions are appropriately shown in other figures so that the illustrated directions correspond to those in FIG. 1. In the following description, when specifying the directional orientation, the direction indicated by the arrow in each figure is “+” and the opposite direction from it is “−”, and positive and negative signs are used together in the directional notation. Hereinafter, the +Z direction is also referred to as “upper”, and the −Z direction is also referred to as “lower”.

The three-dimensional molding system 10 includes a three-dimensional molding device 100 and an information process device 400. The three-dimensional molding device 100 of this embodiment is a device that molds a molded object using a material push out method. Three-dimensional molding device 100 includes a control section 300 that controls each section of the three-dimensional molding device 100. The control section 300 and the information process device 400 are connected so that they can communicate with each other.

Three-dimensional molding device 100 is equipped with a molding section 110, which generates and discharges a molding material, a molding stage 210, which serves as a base of a molded object, and a movement mechanism 230, which controls a position where the molding material is discharged.

The molding section 110 discharges molding material, which is plasticized from solid state material, onto the stage 210 under the control of the control section 300. The molding section 110 has a material supply section 20, which is a supply source of raw material before it is converted into molding material, a plasticizing section 30, which converts the raw material into molding material, and a discharge section 60, which discharges the molding material.

The material supply section 20 supplies the raw material MR to the plasticizing section 30. The material supply section 20 is comprised, for example, of a hopper that holds the raw material MR. The material supply section 20 is connected to the plasticizing section 30 through a communication path 22. The raw material MR is supplied to the material supply section 20 in the form of powder or pellets.

The plasticizing section 30 plasticizes the raw material MR, which is supplied from the material supply section 20, to generate a paste-like molding material, which has fluidity, and leads it to the discharge section 60. In this embodiment, “plasticization” means a concept including melting, and means a change from a solid state to a fluid state. Specifically, for material that undergoes a glass transition, “plasticization” means that the temperature of the material is raised to or above its glass transition temperature. For material that does not undergo glass transition, “plasticization” means that the temperature of the material is raised to or above the melting point.

The plasticizing section 30 has a screw case 31, a drive motor 32, a flat screw 40, and a barrel 50. The flat screw 40 is also referred to as a rotor or scroll. The barrel 50 is also referred to as a screw facing section.

The flat screw 40 is housed in the screw case 31. An upper surface 47 of the flat screw 40 is connected to the drive motor 32, and the flat screw 40 is rotated in the screw case 31 by a rotational drive force generated by the drive motor 32. The drive motor 32 is driven under the control of the control section 300. The flat screw 40 may be driven by the drive motor 32 via a reduction gear.

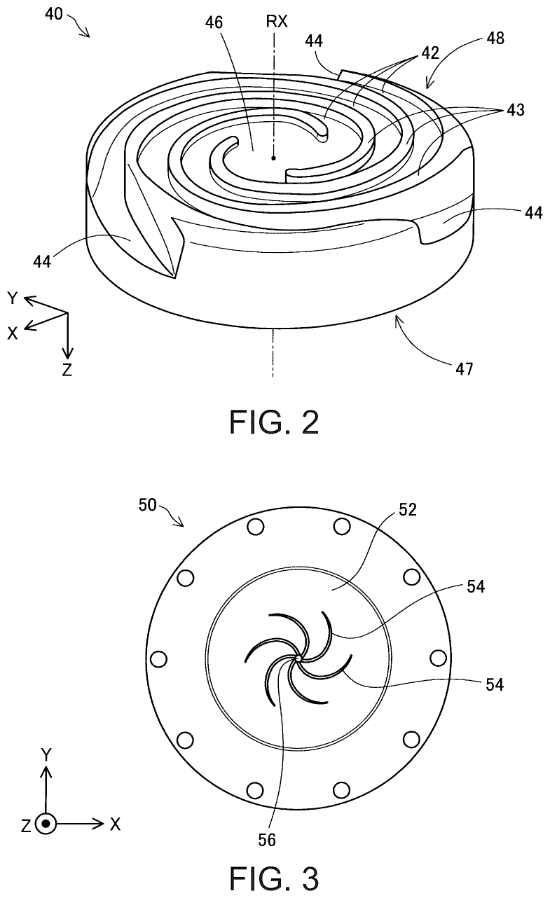

FIG. 2 is a perspective view showing a schematic configuration of a lower surface 48 side of the flat screw 40. The flat screw 40 shown in FIG. 2 is illustrated with a positional relationship between the upper surface 47 and the lower surface 48 shown in FIG. 1 reversed in the vertical direction for facilitating understanding of the technology. The flat screw 40 has a substantially cylindrical shape whose length in an axial direction, which is a direction along its central axis, is smaller than a length in a direction perpendicular to the axial direction. The flat screw 40 is arranged so that a rotation axis RX, which serves as a rotation center of the flat screw 40, is parallel to the Z direction.

A whorl shape groove section 42 is formed on a lower surface 48 of the flat screw 40, which is a surface intersecting the rotation axis RX. The communication path 22 of the material supply section 20 described above communicates with the groove section 42 from the side surface of the flat screw 40. In this embodiment, three groove sections 42, which are spaced apart, are formed by the ridge portions 43. The number of the groove sections 42 is not limited to three, and may be one or two or more. The groove section 42 is not limited to the whorl shape, may be a spiral shape or an involute curve shape, or may be a shape extending so as to draw an arc shape from the central portion to the outer periphery.

As shown in FIG. 1, the lower surface 48 of the flat screw 40 faces the upper surface 52 of the barrel 50, and a space is formed between the groove section 42 of the lower surface 48 of the flat screw 40 and the upper surface 52 of the barrel 50. The raw material MR is supplied into this space between the flat screw 40 and the barrel 50 from the material supply section 20 through the material inflow port 44 shown in FIG. 2.

The barrel heater 58 is embedded in the barrel 50 to heat the raw material MR fed into the groove sections 42 of the rotating flat screw 40. A communication hole 56 is provided at the center of the barrel 50.

FIG. 3 is a schematic plan view showing the upper surface 52 side of the barrel 50. The upper surface 52 of the barrel 50 has a plurality of guide grooves 54 that are connected to the communication hole 56 and that extend in a whorl shape from the communication hole 56 toward the outer periphery. One end portion of the guide grooves 54 may not be connected to the communication hole 56. It is also possible to omit the guide grooves 54.

The raw material MR supplied into the groove sections 42 of the flat screw 40 flows along the groove sections 42 by the rotation of the flat screw 40 while being plasticized in the groove sections 42, and is guided to the center portion 46 of the flat screw 40 as the molding material. The paste-like molding material, which has fluidity and flowed into the center portion 46, is supplied to the discharge section 60 through the communication hole 56 provided in the center of the barrel 50. Note that in the molding material, not all types of substances that constitute the molding material need to be plasticized. The molding material should be converted into a fluidity state as a whole by plasticizing at least some types of substances that constitute the molding material.

The discharge section 60 in FIG. 1 has a nozzle 61, which discharges the molding material, a flow path 65 for the molding material, which is provided between the flat screw 40 and the nozzle opening 62, and a discharge control section 77, which controls the discharge of the molding material.

The nozzle 61 is connected to the communication hole 56 of the barrel 50 through the flow path 65. The nozzle 61 discharges the molding material generated in the plasticizing section 30 from the nozzle opening 62, which is a tip end portion of the nozzle 61, toward the stage 210.

The discharge control section 77 has a discharge adjustment section 70 that opens and closes the flow path 65, and a suction section 75 that sucks and temporarily stores the molding material.

The discharge adjustment section 70 is provided in the flow path 65, and changes the opening degree of the flow path 65 by rotating in the flow path 65. In this embodiment, the discharge adjustment section 70 is composed of a butterfly valve. The discharge adjustment section 70 is driven by a first drive section 74 under the control of the control section 300. The first drive section 74 is composed of, for example, a stepping motor. The control section 300 can adjust a flow amount of the molding material, which flows from the plasticizing section 30 to the nozzle 61, that is, the amount of molding material discharged from the nozzle 61, by controlling the rotation angle of the butterfly valve using the first drive section 74. The discharge adjustment section 70 can adjust the discharge amount of the molding material and can control ON and OFF of the outflow of the molding material.

The suction section 75 is connected between the discharge adjustment section 70 and the nozzle opening 62 in the flow path 65. The suction section 75 temporarily sucks the molding material from the flow path 65 when the discharge of the molding material from the nozzle 61 is stopped. By this, it can suppress a tail-dragging phenomenon in which the molding material drips from the nozzle opening 62 in a string-like manner. In this embodiment, the suction section 75 is composed of a plunger. The suction section 75 is driven by a second drive section 76 under the control of the control section 300. The second drive section 76 is composed of, for example, a stepping motor and a rack and pinion mechanism that converts rotational force of the stepping motor into translation movement of the plunger.

The stage 210 is located at a position facing the nozzle opening 62 of the nozzle 61. In the first embodiment, the molding surface 211 of the stage 210, which faces the nozzle opening 62 of the nozzle 61, is arranged to be parallel to the X and Y directions, that is, the horizontal direction. The stage 210 has a stage heater 212 that suppresses rapid cooling of the molding material discharged onto the stage 210. The stage heater 212 is controlled by the control section 300.

The movement mechanism 230 changes the relative position between the stage 210 and the nozzle 61 under the control of the control section 300. In this embodiment, the position of the nozzle 61 is fixed, and the movement mechanism 230 moves the stage 210. The movement mechanism 230 is composed of a three-axis positioner that moves the stage 210 in three-axis directions of X, Y, and Z directions by drive forces of three motors. In this specification, unless otherwise specified, a movement of the nozzle 61 means to relatively move the nozzle 61 or the discharge section 60 with respect to the stage 210.

Note that in another embodiment, instead of the configuration in which the stage 210 is moved by the movement mechanism 230, a configuration may be adopted in which the nozzle 61 is moved with respect to the stage 210 by the movement mechanism 230 while the position of the stage 210 is fixed. A configuration may be adopted in which the stage 210 is moved in the Z direction and the nozzle 61 is moved in the X and Y directions by the movement mechanism 230, or a configuration may be adopted in which the stage 210 is moved in the X and Y directions and the nozzle 61 is moved in the Z direction by the movement mechanism 230. Even using these configurations, the relative positional relationship between the nozzle 61 and the stage 210 can be changed.

Although only one molding section 110 is illustrated in FIG. 1, the three-dimensional molding device 100 may be equipped with a plurality of molding sections 110. By providing a plurality of molding sections 110, different types of molding materials can be discharged from each molding section 110. For example, it is possible to mold the main body of the molded object and the support structure, which supports the molded object, with different types of molding materials.

The control section 300 is a control device that controls the operation of the entire three-dimensional molding device 100. The control section 300 is configured with a computer with one or more processors 310, a storage device 320 consisting of a main storage device and an auxiliary storage device, and an input and output interface for input and output of signals to and from the outside. The processor 310, by executing the program stored in the storage device 320, controls the molding section 110 and the movement mechanism 230 to mold the molded object on the stage 210 according to the molding data obtained from the information process device 400. Note that the control section 300 may be realized by a combination of circuits instead of being composed by a computer.

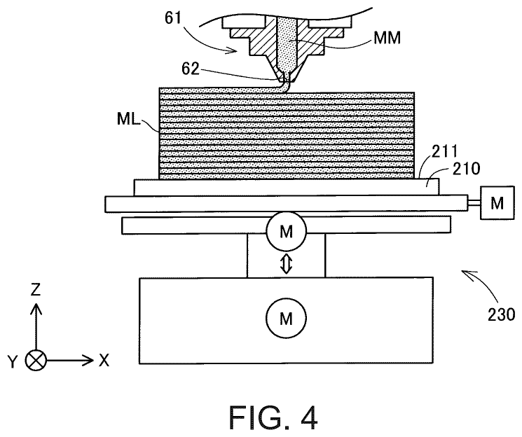

FIG. 4 is an explanatory view schematically showing how the three-dimensional molding device 100 molds the molded object. In the three-dimensional molding device 100, as described above, the molding material MM is generated by plasticizing the solid raw material MR. The control section 300 maintains the distance between the molding surface 211 of the stage 210 and the nozzle 61, and discharges molding material MM from the nozzle 61 in the direction along the molding surface 211 of the stage 210 while changing the position of the nozzle 61 with respect to the stage 210. The molding material MM discharged from the nozzle 61 is continuously deposited in the movement direction of the nozzle 61.

The control section 300 repeats the movement of the nozzle 61 to form a layer ML. After forming one layer ML, the control section 300 moves the position of the nozzle 61 with respect to the stage 210 in the Z direction, which is a layer stacking direction. Then, molded objects are formed by stacking an additional layer ML on top of the previously formed layer ML.

The control section 300 may, for example, temporarily suspend discharging the molding material from the nozzle 61 when the nozzle 61 moves in the Z direction after the molding of one layer ML is completed, or when there are multiple independent molding regions in a single layer. In this case, the discharge adjustment section 70 closes the flow path 65 to stop the discharge of molding material MM from the nozzle opening 62, and the suction section 75 temporarily sucks the molding material inside the nozzle 61. After changing the position of nozzle 61, the control section 300 resumes the deposition of molding material MM from the changed position of nozzle 61 by opening the flow path 65 by the discharge adjustment section 70 while discharging the molding material in the suction section 75.

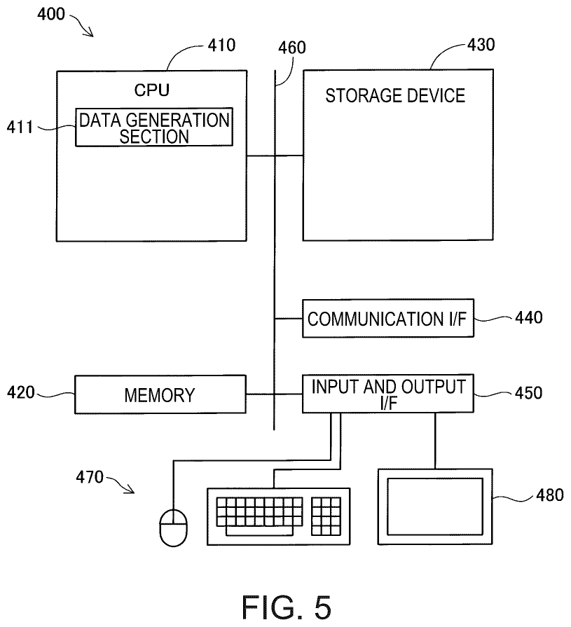

FIG. 5 is an explanatory diagram showing a schematic configuration of the information process device 400. The information process device 400 is configured as a computer in which CPU 410, a memory 420, a storage device 430, a communication interface 440, and an input and output interface 450 are interconnected by a bus 460. An input device 470, such as a keyboard and a mouse, and a display section 480, such as a liquid crystal display, are connected to the input and output interface 450. The information process device 400 is connected to the control section 300 of the three-dimensional molding device 100 via the communication interface 440.

The CPU 410 functions as a data generation section 411 by executing a program stored in the storage device 430.

The data generation section 411 generates molding data. The molding data includes main body data for molding the molded object and support data for molding the support structure. The support structure is a structure that is molded in a support region to support the molded object.

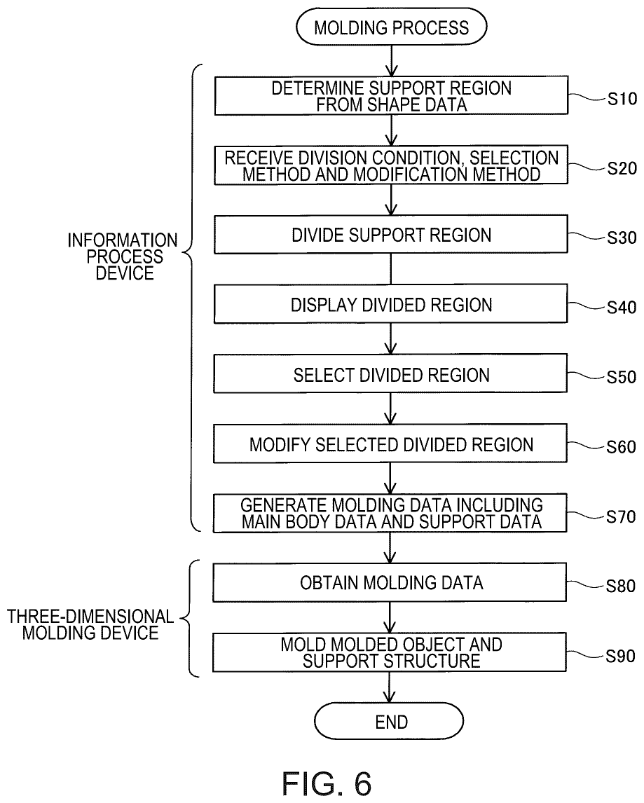

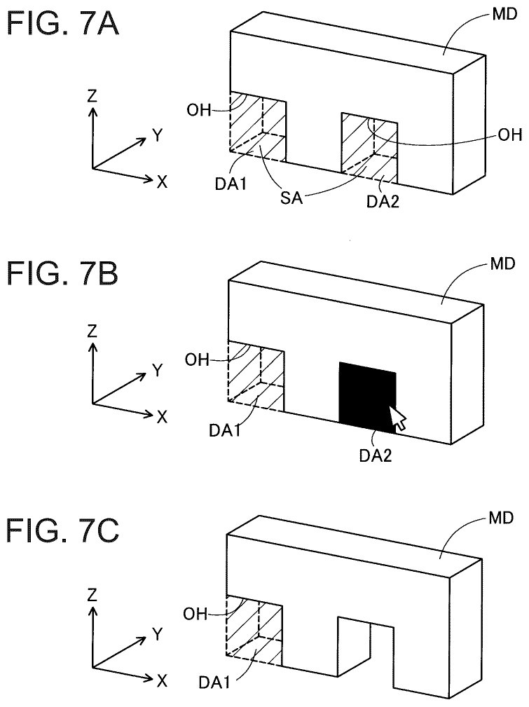

FIG. 6 is a flowchart of a molding process executed in the three-dimensional molding system 10. FIGS. 7A to 7C are explanatory diagrams of the molding process. The molding process is a process for realizing a manufacturing method of the three-dimensional molded object. The process of steps S10 to S70 shown in FIG. 6 are executed in the information process device 400, the process of steps S80 to S90 are executed in the three-dimensional molding device 100.

In step S10, the data generation section 411 of the information process device 400 obtains shape data representing a three-dimensional shape of the molded object from another computer, a recording medium, or the storage device 430, and determines the support region from the shape data. The shape data is data representing the shape of the three-dimensional molded object that was generated using a three-dimensional CAD software, three-dimensional CG software, or the like. For example, data in STL format or AMF format can be used as the shape data. The support region is determined to be a region below an overhang section of the molded object, that is, a region between the overhang section and the molding surface 211. The overhang section is a portion that is protruding in the molded object without any support below it. In this embodiment, the term “overhang section” also includes a bridge section. A bridge section is a bridge-like portion in the molded object that is supported at both ends. FIG. 7A shows a state in which support regions SA are determined below an overhang section OH of a rectangular parallelepiped, two-legged shape molded object MD. In FIGS. 7A, 7B, 7C and subsequent figures, the support region SA is indicated using hatching. The data generation section 411 controls the display section 480 and, as shown in FIG. 7A, displays the three-dimensional shape of the molded object MD and the support regions that were determined in step S10. Step S10 corresponds to a first step in this application.

In step S20, the data generation section 411 receives designations of division information, a selection method, and a modification method from the user via the input device 470. Step S20 corresponds to a second step and a third step in this application.

Division information is information for dividing the support region SA determined in step S10 into a plurality of regions. Hereinafter, the divided support region is referred to as a divided region. The division information includes, for example, the following information.
A1. Information for dividing a region in the support region that is continuous in at least one direction from amongst the Z direction, which is the layer stacking direction, and the X and Y directions, which are directions along the molding surface, as a single divided region.
A2. Information for dividing a region in the support region that is specified in A1, and with a constant length in the layer stacking direction or with a displacement in length that is within a predetermined range, as a single divided region.
A3. Information for dividing a region in the support region that is specified in A1, and with a constant length in the layer stacking direction or with a displacement in length that is within a predetermined range, and with a displacement of an upper surface or a lower surface in the direction along the molding surface that is continuous within a predetermined range, as a single divided region.
A4. Information for dividing a region in the support region that is specified in A1 and where an inclined angle of an overhang section OH with respect to the molding surface is constant, or where a change in the inclined angle of the overhang section OH is within a predetermined range, as a single divided region.

The division information A1 is used to define a single non-separated region as a divided region. The division information A2 is used to divide a region that is discontinuous in the length in the layer stacking direction in a single non-separated region. The division information A3 is used to divide a region that has the same length in the layer stacking direction but that is discontinuous in shape in the direction along the molding surface in a single non-separated region. In the division information A2 and A3, “region that is discontinuous” means a region that is stepped shape on the upper surface or the lower surface of the support region. The division information A4 is used to divide a region at a portion where the inclined angle of the overhang section OH greatly changes in the single non-separated region.

The data generation section 411 displays a screen for specifying any one of above A1 to A4 by controlling the display section 480. The data generation section 411 receives the designation of the division information by the user through the input device 470. The user can specify one or more sets of division information among the above division information sets A1 to A4. If no specification is made by the user, the data generation section 411 may receive one or more predetermined sets of division information as default division information among the above sets of division information A1 to A4.

The selection method is a method for selecting one or more divided regions from a plurality of divided regions, which are divided according to the division information. The selection method includes, for example, the following methods:
B1. A method of selecting a divided region by placing a mouse cursor on a desired divided region and clicking on it.
B2. A method of selecting a divided region that exists within an area dragged by the mouse cursor.
B3. A method of automatically selecting a divided region whose volume is less than or equal to a specified volume.
B4. A method of automatically selecting a divided region located below the overhang section OH whose inclined angle with respect to the molding surface is higher than or equal to a predetermined threshold value (for example, 45 degrees) or is within a predetermined range.
B5. A method of automatically selecting a divided region whose height is higher than or equal to a threshold value, is lower than or equal to a threshold value, or is within a predetermined range.

The data generation section 411 displays a screen for specifying any one of the selection methods B1 to B5 by controlling the display section 480. The data generation section 411 receives a designation of the selection method by the user through the input device 470. If no specification is made by the user, the data generation section 411 may receive a predetermined selection method as a default selection method among the above selection methods B1 to B5.

The modification method is a method of modification to be applied to the selected divided region. The modification method includes, for example, the following methods:
C1. Delete the divided region.
C2. Change a molding condition of the support structure to be molded in the divided region. The molding condition includes at least one of a filling rate, a type of a material to be discharged, and a molding pattern.

The data generation section 411 displays a screen for specifying either the modification method C1 or C2 by controlling the display section 480. The data generation section 411 receives the designation of the modification method by the user through the input device 470. If no designation is made by the user, the data generation section 411 may receive a predetermined modification method as a default modification method among the above modification methods C1 and C2.

In step S30, the data generation section 411 divides the support region according to the division information received in step S20. For example, in the molded object MD shown in FIG. 7A, when the division information A1, that is, “information for dividing a region in the support region that is continuous in at least one direction of the Z direction, which is the layer stacking direction, and of the X and Y directions, which are directions along the molding surface, as a single divided region,” is designated, then the support region SA, which is continuous in the Z direction and in either the X or Y direction, is divided as one divided region. Thus, the two support regions SA, which are determined below the two overhang sections OH, are divided as separate divided region DA1 and divided region DA2.

In step S40, the data generation section 411 displays the plurality of divided regions on the display section 480 in a distinguishable manner. Step S40 corresponds to a display step in this application.

In step S50, the data generation section 411 selects the divided region to be modified according to the selection method received in step S20. For example, when the selection method B1, that is, “a method of selecting a divided region by placing a mouse cursor on a desired divided region and clicking on it,” is designated, then as shown in FIG. 7B, the user uses the mouse cursor displayed on the screen to select a divided region to be modified. FIG. 7B shows a state in which the divided region DA2 was selected using the mouse cursor so that the color of the divided region DA2 is changed. Step S50 corresponds to a selection step in this application.

In step S60, the data generation section 411 modifies the divided region selected in step S50 according to the modification method received in step S20. For example, when the above modification method C1, that is, “delete the divided region,” is designated, as shown in FIG. 7C, the data generation section 411 deletes the divided region DA2 selected in step S50.

In step S70, the data generation section 411 generates the molding date. The molding data includes the support data and the main body data as described above. In step S70, the data generation section 411 generates, according to the support region determined in step S10 and the modification information received in step S60, the support data for molding the support structure by the three-dimensional molding device 100. The data generation section 411 also generates the main body data for molding the molded object that is supported by the support structure. Step S70 corresponds to a fourth step in this application.

When generating the main body data, the data generation section 411 analyzes the shape data obtained in step S10 and slices the shape of the molded object MD into multiple layers along the X-Y plane. The data generation section 411 then generates movement path information that indicates the movement path of the nozzle 61 to form the contour of each layer as well as to fill its internal region in a predetermined filling rate and a molding pattern. The movement path information includes data indicating a plurality of linear movement paths. Each movement path included in the movement path information includes discharge amount information that indicates the discharge amount of molding material discharged in that movement path. The data generation section 411 generates the main body data by generating the movement path information and the discharge amount information for all the layers of the molded object MD. The main body data is represented by, for example, G-code.

When generating the support data, the data generation section 411 specifies a support region of which the divided region deleted in step S60 is excluded from the support region specified in step S10, and slices the shape of the specified support region into multiple layers along the X-Y plane. Then, the data generation section 411 generates the movement path information for molding each layer of the support region, according to the molding condition modified in step S60 or the molding condition determined in advance. Each movement path included in the movement path information includes the discharge amount information that indicates the discharge amount of the molding material discharged in that movement path. The data generation section 411 generates the support data by generating the movement path information and the discharge amount information for all the layers of the support region. The support data is represented by, for example, G-code, similar to the main body data.

In step S80, the control section 300 of the three-dimensional molding device 100 obtains the molding data generated by the information process device 400 in step S70 from the information process device 400.

In step S90, the control section 300 controls the discharge section 60 and the movement mechanism 230 according to the molding data obtained from the information process device 400 to mold the molded object and the support structure on the molding surface 211 of the stage 210. Step S90 corresponds to a fifth step in this application. After the molding processes described above are completed, the user separates or removes the support structure from the molded object.

According to the first embodiment described above, it is possible to divide the support region, which is automatically determined, in accordance with the designated division information, to delete each divided region, or to change the molding condition of the support structure to be molded in the divided region. Therefore, the support region automatically arranged can be easily customized.

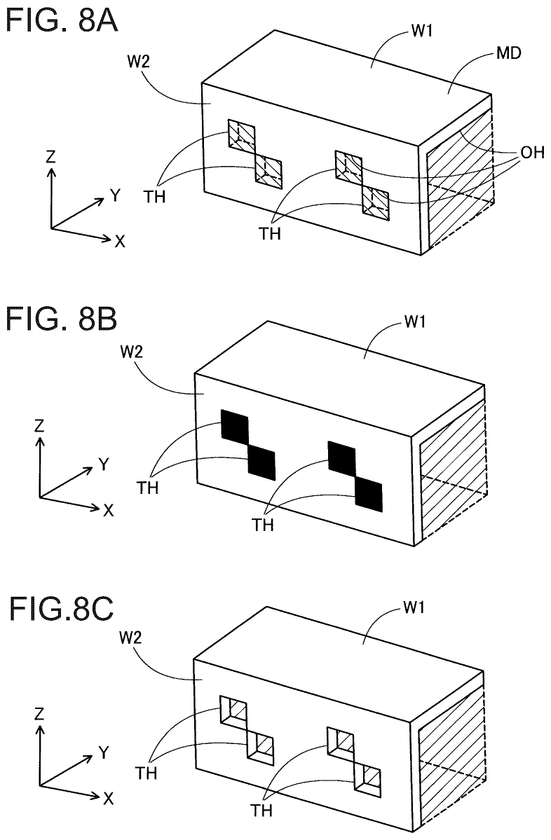

FIGS. 8A, 8B and 8C through FIGS. 13A, 13B and 13C are explanatory diagrams showing other examples of the molding process.

FIG. 8A shows a molded object MD with an upper wall W1 and one side wall W2. Four through holes TH are formed in the side wall W2. In such a molded object MD, the upper wall W1 becomes the overhang section OH, and portions of the side wall W2 that are located above the through holes TH also become the overhang sections OH. Thus, in step S10 in FIG. 6, the support region is determined to be a portion below the upper wall W1 and portions inside the through holes TH. It is assumed that in step S20, the division information A3 above, that is, “information for dividing a region in the support region that is specified in A1, that a length in the layer stacking direction is constant or a displacement of the length is within a predetermined range, and that a displacement of an upper surface or a lower surface in the direction along the molding surface is continuous within a predetermined, as a single divided region,” is designated as the division information. In this case, in step S30, the data generation section 411 divides each of the four support regions in the four through holes TH and the support region below the upper wall W1 as one divided region. Thus, the support region is divided into five divided regions in total. Assuming that the selection method B3 above, that is, “a method of automatically selecting a divided region whose volume is less than or equal to a specified volume,” is designated as the selection method in step S20 above, then as shown in FIG. 8B, the data generation section 411 automatically selects, for example, four divided regions in the through holes TH out of the five divided regions in step S50. Then, assuming that the modification method C1 above, that is, “delete the divided region,” is designated as the modification method in step 20 above, as shown in FIG. 8C, the data generation section 411 collectively deletes the four divided regions in the through holes TH in step S60. When the modification method C2 above, that is, “change a molding condition of the support structure to be molded in the divided region,” is designated as the modification method, the data generation section 411 collectively changes the molding condition of the four divided regions in the through holes TH in step S60.

As shown in FIGS. 8A, 8B and 8C, when a divided region with a predetermined volume or smaller is automatically selected, the user convenience is improved because the user does not need to individually select divided regions with small volume.

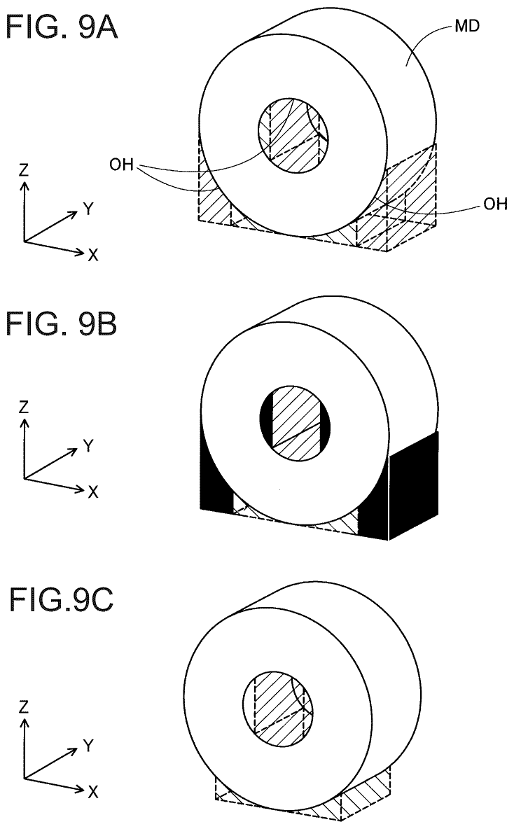

FIG. 9A shows a cylindrical-shaped molded object MD having a central axis along the Y direction. In step S10 in FIG. 6, a support region is determined to be a portion within a through hole in the center and a portion between the outer circumferential surface of the lower half of the molded object and the molding surface. It is assumed that in step S20, the division information A4 above, that is, “information for dividing a region in the support region that is specified in A1 and where an inclined angle of an overhang section OH with respect to the molding surface is constant, or where a change in the inclined angle of the overhang section OH is within a predetermined range, as a single divided region,” is designated as the division information. As a result, in step S30, for example, the data generation section 411, as shown in FIG. 9A, divides the support region in the through hole into three divided regions, and divides the support region located below the lower half of the molded object MD into four divided regions. In the example of FIG. 9A, the support region is divided into seven divided regions in total. It is assumed that in step S20 above, the above selection method B4, that is, “a method of automatically selecting a divided region located below the overhang section OH whose inclined angle with respect to the molding surface is higher than or equal to a predetermined threshold value or is within a predetermined range,” is designated as the selection method. As a result, in step S50, for example, as shown in FIG. 9B, outer two divided regions of the three divided regions in the through hole are selected, and outer two divided regions of the four divided regions located below the lower half of the molded object MD are selected. Then, assuming that the modification method C1 above, that is, “delete the divided region,” is designated as the modification method in step S20 above, as shown in FIG. 9C, the outer two divided regions in the through hole and the outer two divided regions located below the lower half of the molded object are deleted in step S60.

As described above, when the divided region is automatically selected according to the inclined angle of the overhang section OH, the user does not need to individually select and delete the divided region below the overhang section OH with a large inclined angle that can be molded without a support structure. Thus, the user convenience is improved.

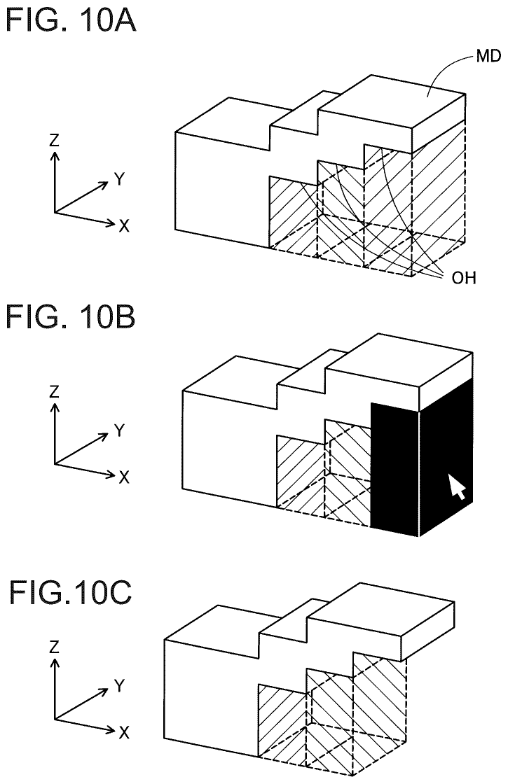

FIG. 10A shows a molded object MD having an overhang section OH in the form of a staircase with three steps. In step S10 of FIG. 6, the support region is determined to be the entire region below the overhang section OH. It is assumed that in step S20, the division information A2 above, that is, “information for dividing a region in the support region that is specified in A1, and that a length in the layer stacking direction is constant or a displacement of the length is within a predetermined range, as a single divided region,” is designated as the division information. Then, in step S30, the data generation section 411 divides a portion whose length from the molding surface to the overhang section OH is within a certain range as one divided region. In the example shown in FIG. 10A, the support region is divided into three divided regions in total. Assuming that the selection method B1 above, that is, “a method of selecting a divided region by placing a mouse cursor on a desired divided region and clicking on it” is designated as the selection method in step S20 above, then as shown in FIG. 10B, for example, the outermost divided region among the three divided regions is selected in step S50. Then, assuming that the modification method C1 above, that is, “delete the divided region,” is designated as the modification method in step S20 above, as shown in FIG. 10C, then the outermost divided region selected in step S50 is deleted in step S60.

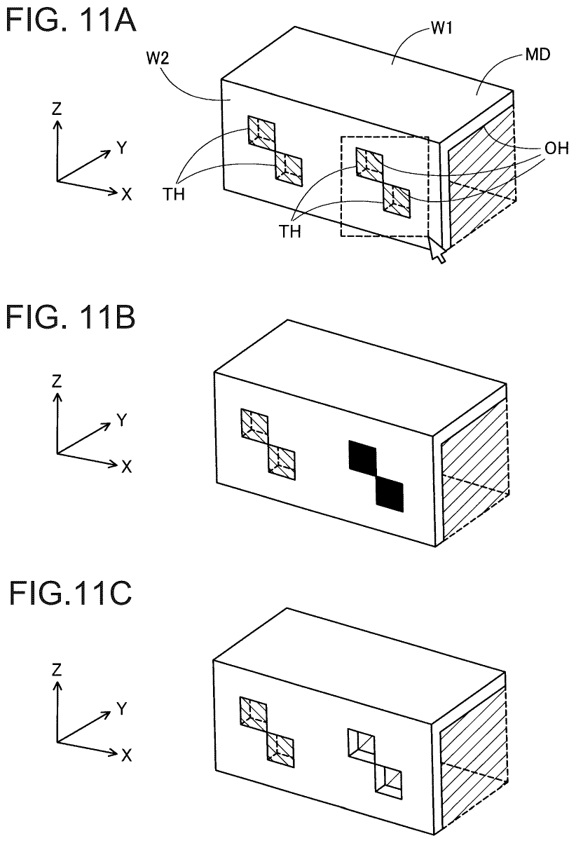

FIG. 11A shows a molded object MD, which is the same to the molded object shown in FIG. 8A, with an upper wall W1 and one side wall W2. FIG. 11A shows that the four support regions in the four through holes TH and the support region below the upper wall W1 are each divided into one divided region, as in FIG. 8A. In step S20 above, assuming that the selection method B2, that is, “a method of selecting a divided region that exists within an area dragged by the mouse cursor,” is designated as the selection method then, for example, as shown in FIG. 11B, the two through holes TH in the dragged area shown by the dotted line in FIG. 11A are selected in step S50. Then, assuming that the modification method C1 above, that is, “delete the divided region” is designated as the modification method in step 20 above, as shown in FIG. 11C, the two divided regions selected in step S50 are deleted in step S60.

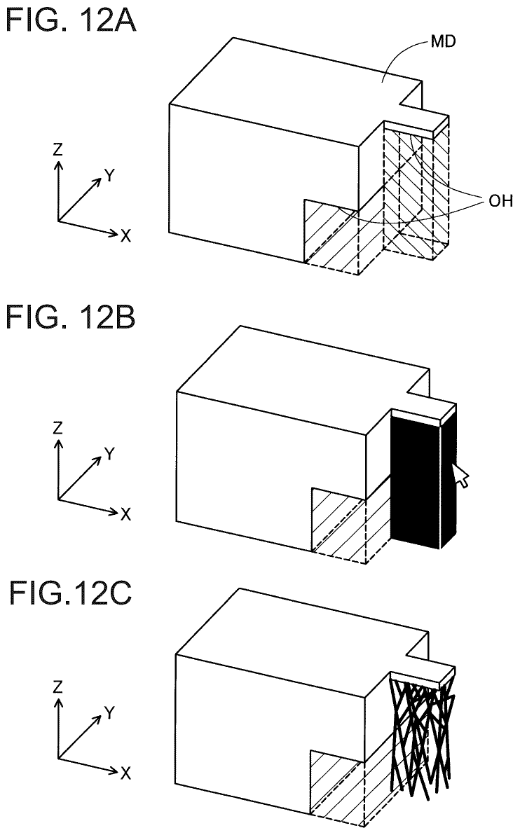

FIG. 12A shows a molded object MD that has two steps of overhang sections OH with different widths and heights. In step S10 of FIG. 6, the support region is determined to be the entire region below the overhang section OH. It is assumed that in step S20, the division information A2 above, that is, “information for dividing a region in the support region that is specified in A1, and that a length in the layer stacking direction is constant or a displacement of the length is within a predetermined range, as a single divided region,” is designated as the division information. Then, in step S30, the data generation section 411 divides a portion whose length from the molding surface to the overhang section OH in the layer stacking direction is within a certain range as one divided region. In the example shown in FIG. 12A, the support region is divided into two divided regions in total. Assuming that the selection method B1 above, that is, “a method of selecting a divided region by placing a mouse cursor on a desired divided region and clicking on it,” is designated as the selection method in step S20 above then, as shown in FIG. 12B, for example, outer divided region is selected among the two divided regions in step S50. Then, assuming that the modification method C2 above, that is, “change a molding condition of the support structure to be molded in the divided region” is designated as the modification method in step S20 above then, as shown in FIG. 12C, the support structure is molded under a different molding condition from an original molding condition of the divided region in step S60. FIG. 12C shows an example where the molding pattern among the molding conditions is changed from a columnar pattern to a branch pattern.

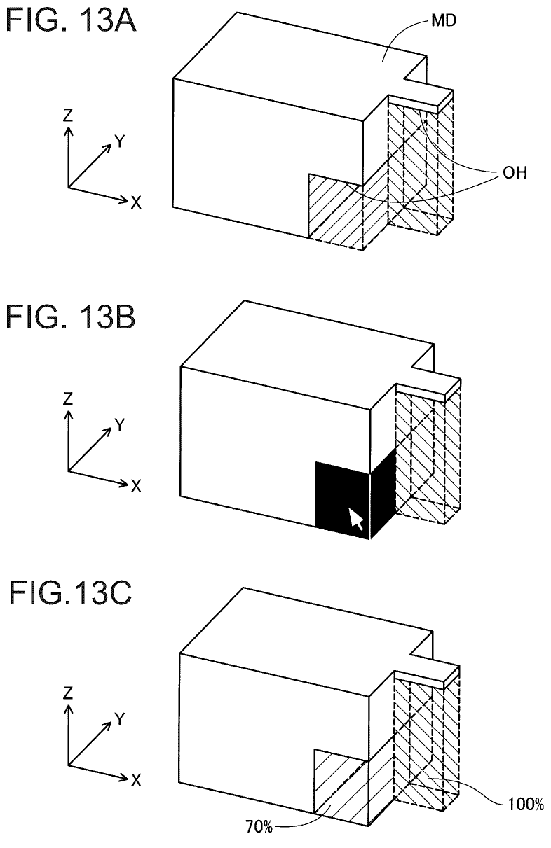

FIG. 13A shows a molded object MD having the same shape as that in FIG. 12A. In step S10 of FIG. 6, the support region is determined to be the entire region below the overhang section OH. It is assumed that in step S20, the division information A2 above, that is, “information for dividing a region in the support region that is specified in A1, and that a length in the layer stacking direction is constant or a displacement of the length is within a predetermined range, as a single divided region,” is designated as the division information. Then, in step S30, the data generation section 411 divides a portion whose length from the molding surface to the overhang section OH in the layer stacking direction is within a certain range as one divided region. In the example shown in FIG. 13A, the support region is divided into two divided regions in total. Assuming that the selection method B1 above, that is, “a method of selecting a divided region by placing a mouse cursor on a desired divided region and clicking on it,” is designated as the selection method in step S20 above then, as shown in FIG. 13B, for example, inner divided region is selected among the two divided regions in step S50. Then, assuming that the modification method C2 above, that is, “change a molding condition of the support structure to be molded in the divided region,” is designated as the modification method in step S20 above, as shown in FIG. 13C, the support structure is molded under a different molding condition from an original molding condition of the divided region in step S60. FIG. 13C shows an example where the filling rate of the molding condition is changed from 100% to 70%. In this embodiment, since at least one of the filling rate, the type of material to be discharged, and the molding pattern can be changed as the molding condition, it is possible to increase the customizability of the support structure molded in the divided region.

### B. Second Embodiment

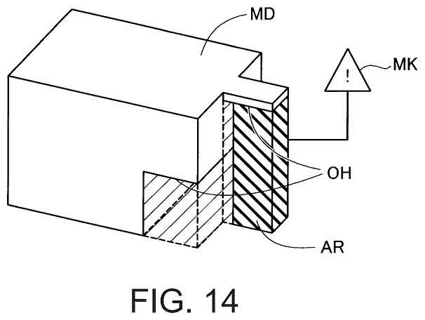

FIG. 14 is a diagram showing a display example of an alert region AR in a second embodiment. In the second embodiment, the process in step S40 of the molding process shown in FIG. 6 is different from that in the first embodiment. The processes other than step S40 and the configuration of the three-dimensional molding system 10 are the same as in the first embodiment.

In this second embodiment, in step S40 of the molding process shown in FIG. 6, the data generation section 411 displays a sign with emphasis on the display section 480 as an alert region AR where the molding is affected if the region in the support region is deleted or its molding condition is changed.

In FIG. 14, a portion of the outer divided region of the two divided regions is highlighted by displaying a striped pattern as the alert region AR and by drawing the warning mark MK from that portion. The data generation section 411 analyzes the shape data representing the three-dimensional shape of the molded object to determine a region in each divided region that meets at least one of the following conditions (a) to (d) and, as shown in FIG. 14, displays with emphasis that region as the alert region AR. In FIG. 14, a region that meets the following condition (c) is displayed as the alert region AR.
(a) A region where the inclined angle of the overhang section OH of the molded object, which is supported by the support structure, with respect to the molding surface is below a predetermined value (for example, 45 degree).
(b) A region where an area of the lower surface of the overhang section OH is greater than or equal to a predetermined value.
(c) A region where a length along a molding surface of the overhang section OH is greater than or equal to a predetermined value.
(d) A region where a weight of the molded object supported by the support structure is greater than or equal to a predetermined value.

According to the second embodiment described above, it is possible to represent the user a region in the support region that affects the molding of the molded object MD. Thus, after the alert region AR is displayed with emphasis, the user can change the molding condition or the like with respect to the alert region AR by selecting the divided region corresponding to the alert region AR. Also, by not selecting the alert region, the support structure can be molded without making any changes to the alert region.

In this embodiment, the data generation section 411 may display each divided region distinguishable on the display section 480 so that the divided region corresponding to the alert region AR is not selectable by the user. In this way, the divided region corresponding to the alert region AR can be prevented from being deleted, and the possibility that the molding will be affected can be suppressed.

### C. Other Embodiments

C-1. In the above embodiments, the division information for dividing the support region is not limited to the sets of division information A1 to A4 above. For example, it may be possible to select information for dividing a region in the support region that has a constant cross-sectional area or a variation of the cross-sectional area within a predefined range, as one divided region. According to such division information, the support region can be divided at a portion where the cross-sectional area greatly changes.

C-2. In the above embodiments, the molding section 110 plasticizes the material using the flat screw 40. In contrast, the molding section 110 may plasticize the material by rotating an inline screw, for example. Further, the molding section 110 may plasticize filamentous material with a heater.

C-3. In the above embodiments, the material push out method is described as an example of stacking layers of a plasticized material, but various methods can be applied to this disclosure, such as the inkjet method, direct metal deposition (DMD) method, binder jet method, and others.

C-4. In the above embodiments, the support region SA, which is determined in step S10 in FIG. 6, is divided according to the division information received in step S20. In contrast, the data generation section 411 may divide only the support region SA, which was selected by the user among the support regions SA determined in step S10, according to the division information received in step S20. For example, among the support regions SA determined in step S10, only the support regions SA that exist within the range where the mouse cursor is dragged may be divided according to the division information. By this, the user can selectively divide the support region SA that requires customization. Therefore, unnecessary division of the support region SA can be suppressed and the time required for processing by the data generation section 411 can be reduced.

C-5. The division information A2 and A3 in the above embodiments includes information for dividing a region whose length in the layer stacking direction is constant or whose length displacement is within a predetermined range as a single divided region. In contrast, the division information A2 and A3 may include information for dividing a region whose height in the layer stacking direction is constant or whose displacement of the height is within a predetermined range as a single divided region. The length in the layer stacking direction is the distance from the lower end to the upper end, the height in the layer stacking direction is the distance from the molding surface to the upper end.

### D. Other Aspects

The present disclosure is not limited to the above described embodiments, and can be realized in various configurations without departing from the intent thereof. For example, the technical features of the embodiments corresponding to the technical features in each aspect described below can be appropriately replaced or combined in order to solve a part or all of the problems described above or in order to achieve a part or all of the effects described above. In addition, unless the technical features are described as essential in the present specification, the technical features can be appropriately deleted.

(1) According to a first aspect of the present disclosure, there is provided a manufacturing method of a three-dimensional molded object that molds a molded object and a support structure, which supports the molded object, by stacking layers on a molding surface. This manufacturing method includes a first step of determining support region in which the support structure is molded; a second step of receiving division information for dividing the support region determined in the first step into a plurality of regions; a third step of receiving modification information that instructs a modification of a molding condition or a deletion of a divided region for at least one of the plurality of divided regions that are divided in accordance with the division information received in the second step; a fourth step of generating support data for molding the support structure by a three-dimensional molding device in accordance with the support region determined in the first step and the modification information received in the third step; and a fifth step of molding the support structure by controlling the three-dimensional molding device in accordance with the support data. According to this aspect, the support region can be easily customized.

(2) In the above aspect, the division information may include information for dividing a region in the support region that is continuous in at least one of the layer stacking direction and the direction along the molding surface, as one divided region. According to this aspect, a single non-separated region can be divided as one divided region.

(3) In the above aspects, the division information may include information for dividing a region in the support region where a length in the layer stacking direction is constant or a displacement of the length is within a predetermined range, as one divided region. According to this aspect, a region that is discontinuous in length in the layer stacking direction can be divided.

(4) In the above aspects, the division information may include information for dividing a region in the support region where a length in the layer stacking direction is constant or a displacement of the length is within a predetermined range and where a displacement of an upper surface or a lower surface in a direction along the molding surface is continuous within a predetermined range, as one divided region. According to this aspect, it is possible to divide regions that have the same length in the layer stacking direction but are discontinuous in shape in the direction along the molding surface.

(5) In the above aspect, the division information may include information for dividing a region in the support region where an inclined angle of an overhang section of the molded object, which is supported by the support structure, with respect to the molding surface is constant or a displacement of the inclined angle is within a predetermined range, as one divided region. According to this aspect, a support region can be divided at portion where the inclined angle of the overhang section greatly changes.

(6) In the above aspects, the third step may include a selection step that receives a selection of a divided region to be the target of a modification of the molding condition or a target of deletion, and in the selection step, among the plurality of divided regions that are divided, a divided region with a predetermined volume or less may be selected collectively. According to this aspect, the user's convenience is improved.

(7) In the above aspects, the molding condition may include at least one of a filling rate, a type of a material to be discharged, and a molding pattern. According to this aspect, the customizability of the support structures that are molded into the divided regions can be increased.

(8) In the above aspects, the method may further including a display step for displaying the plurality of divided regions on a display section in a distinguishable manner, wherein in the display step, at least one of the following may be displayed with emphasis: (a) a region where an inclined angle of an overhang section of the molded object, which is supported by the support structure, with respect to the molding surface is less than a predetermined value, (b) a region where an area of a lower surface of the overhang section is equal to or greater than a predetermined value, (c) a region where a length of the overhang section along the molding surface is equal to or greater than a predetermined value, or (d) a region where a weight of the molded object supported by the support structure is equal to or greater than a predetermined value. According to this aspect, it is possible to present to the user a region that affects the molding of the molded object.

The present disclosure is not limited to the manufacturing method of the three-dimensional molded object described above, and can be realized by various aspects such as a three-dimensional molding system, an information process device, a computer program, and a non-transitory tangible recording medium in which the computer program is recorded so as to be readable by a computer.

What is claimed is:

1. A manufacturing method of a three-dimensional molded object that, by stacking layers on a molding surface, molds a molded object and a support structure that supports the molded object, the manufacturing method of the three-dimensional molded object comprising:
a first step of determining a support region in which the support structure is molded;
a second step of receiving division information for dividing the support region determined in the first step into a plurality of regions;
a third step of receiving modification information that instructs a modification of a molding condition or a deletion of a divided region for at least one of the plurality of divided regions that are divided in accordance with the division information received in the second step;
a fourth step of generating support data for molding the support structure by a three-dimensional molding device in accordance with the support region determined in the first step and the modification information received in the third step; and
a fifth step of molding the support structure by controlling the three-dimensional molding device in accordance with the support data.

2. The manufacturing method of the three-dimensional molded object according to claim 1, wherein
the division information includes information for dividing, as one divided region, a region in the support region that is continuous in at least one of a layer stacking direction and directions along the molding surface.

3. The manufacturing method of the three-dimensional molded object according to claim 2, wherein
the division information includes information for dividing, as one divided region, a region in the support region where a length in the layer stacking direction is constant or a displacement of the length is within a predetermined range.

4. The manufacturing method of the three-dimensional molded object according to claim 2, wherein
the division information includes information for dividing, as one divided region, a region in the support region where a length in the layer stacking direction is constant or a displacement of the length is within a predetermined range and where a displacement of an upper surface or a lower surface in a direction along the molding surface is continuous within a predetermined range.

5. The manufacturing method of the three-dimensional molded object according to claim 2, wherein
the division information includes information for dividing, as one divided region, a region in the support region where an inclined angle of an overhang section of the molded object, which is supported by the support structure, with respect to the molding surface is constant or a change in inclined angle is within a predetermined range.

6. The manufacturing method of the three-dimensional molded object according to claim 1, wherein
the third step includes a selection step that receives a selection of a divided region to be a target of the modification of the molding condition or a target of deletion, and
in the selection step, among the plurality of divided regions that are divided, a divided region with a predetermined volume or less is selected collectively.

7. The manufacturing method of the three-dimensional molded object according to claim 1, wherein
the molding condition includes at least one of a filling rate, a type of a material to be discharged, and molding pattern.

8. The manufacturing method of the three-dimensional molded object according to claim 1, further comprising:
a display step for displaying the plurality of divided regions on a display section in a distinguishable manner, wherein
in the display step, at least one of the followings is displayed with emphasis,
(a) a region where an inclined angle of an overhang section of the molded object, which is supported by the support structure, with respect to the molding surface is less than a predetermined value,
(b) a region where an area of a lower surface of the overhang section is equal to or greater than a predetermined value,
(c) a region where a length of the overhang section along the molding surface is equal to or greater than a predetermined value, or
(d) a region where a weight of the molded object supported by the support structure is equal to or greater than a predetermined value.
